(19) United States
(12) Patent Application Publication
(10) Pub. No.: US 2024/0281673 A1
(43) Pub. Date: Aug. 22, 2024

(54) PROBLEM DETECTION BASED ON DEVIATION FROM FORECAST

(71) Applicant: Sumo Logic, Inc., Redwood City, CA (US)

(72) Inventors: David M. Andrzejewski, San Francisco, CA (US); Bashyam TCA, Walnut Creek, CA (US); Ryley SK Higa, Honolulu, HI (US); Aaishwarya Bansal, Waterloo (CA)

(21) Appl. No.: 18/172,776

(22) Filed: Feb. 22, 2023

(51) Int. Cl. G06N 5/022

(52) U.S. Cl. CPC G06N 5/022

(57) ABSTRACT

Methods, systems, and computer programs are presented for problem detection based on deviations from the forecasted behavior of a metric. One method includes an operation for selecting a machine learning (ML) model for predicting future values of a time series for a metric. Further, the method includes forecasting, using the ML model, values of the metric for a forecast period. Afterwards, actual values of the metric are collected during the forecast period, and the actual values are compared to the forecasted values. The method further includes operations for determining an anomaly in a behavior of the metric based on the comparison, and causing presentation in a computer user interface (UI) of the anomaly.

### TECHNICAL FIELD

The subject matter disclosed herein generally relates to methods, systems, and machine-readable storage media for detecting problems by analyzing logged data.

### BACKGROUND

On-call engineers are tasked with troubleshooting production issues and finding solutions to recover from malfunctions quickly, having to investigate issues and identify their root causes, which requires deep knowledge about production systems, troubleshooting tools, and diagnosis experience.

Problems are often detected when alerts are generated by the monitoring systems that inform about problems with systems, services, or applications associated with the company products and services. Typically, alarms are generated when the value of a metric goes above or below threshold values (e.g., CPU utilization, amount of memory available).

However, there are many scenarios when a malfunction in the system cannot be detected by a simple value check. For example, a resource utilization during peak business hours may not mean that there is a problem, but the same value at 2 AM may mean that there is a problem. Also, some datasets tend to grow over time (e.g., number of items added to shopping carts), so a metric value today may mean that there is a problem, but the same value may be result of growth three months later and not be associated with a problem scenario.

### BRIEF DESCRIPTION OF THE DRAWINGS

Various of the appended drawings merely illustrate example embodiments of the present disclosure and cannot be considered as limiting its scope.

FIG. 1 illustrates an embodiment of an environment in which machine data collection and analysis is performed.

FIG. 2 is a chart showing the behavior of a metric over time and the forecast value for the future, according to some example embodiments.

FIG. 3 is a chart showing forecasting metric behavior accounting for trends in the metric data, according to some example embodiments.

FIG. 4 shows a chart comparing actual versus forecasted data, according to some example embodiments.

FIG. 5 illustrates anomaly types.

FIG. 6 illustrates additional anomaly types.

FIG. 7 illustrates the training and use of a machine-learning model, according to some example embodiments.

FIG. 8 is a flowchart of a method for selecting the best forecasting model for a metric, according to some example embodiments.

FIG. 9 is a flowchart of a method for detecting problems based on the forecasted data, according to some example embodiments.

FIG. 10 is an architecture for a problem-detection tool, according to some example embodiments.

FIG. 11 is a flowchart of a method for problem detection based on deviations from the forecasted behavior of a metric, according to some example embodiments.

FIG. 12 is a block diagram illustrating an example of a machine upon or by which one or more example process embodiments described herein may be implemented or controlled.

### DETAILED DESCRIPTION

Example methods, systems, and computer programs are directed to problem detection based on deviations from the forecasted behavior of a metric. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one aspect, the data for a metric, collected via logged data or derived from the log data (e.g., error counts, parsed values, metric averages), is analyzed to identify a machine learning (ML) prediction model that can predict the behavior of the data over a period of time based on historical data. The performances of a variety of different model types and model hyper parameters are evaluated to determine which model and hyperparameters are better for predicting future behavior of each metric. After a prediction is made with the selected prediction model, the new data is collected and compared to the prediction. Based on this comparison, anomalies can be detected when the actual behavior does not match the forecasted behavior. When an anomaly is detected, an alert is generated, and tools are provided to the user to help identify the source of potential problems.

One general aspect includes a method that includes an operation for selecting a machine learning (ML) model for predicting future values of a time series for a metric. Further, the method includes forecasting, using the ML model, values of the metric for a forecast period. Afterwards, actual values of the metric are collected during the forecast period, and the actual values are compared to the forecasted values. The method further includes operations for determining an anomaly in a behavior of the metric based on the comparison, and causing presentation in a computer user interface (UI) of the anomaly.

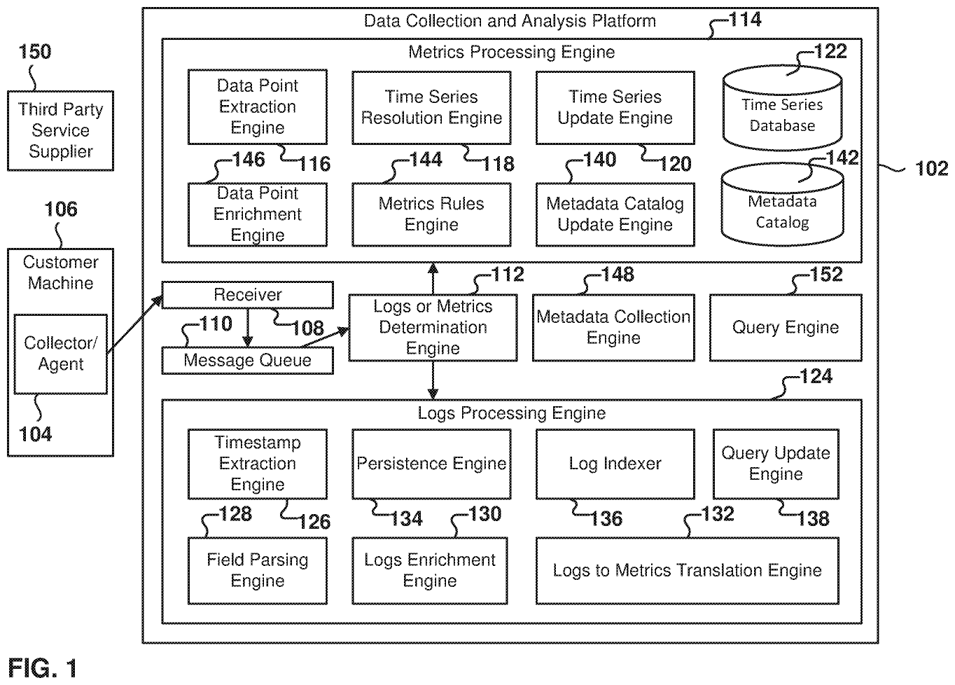

FIG. 1 illustrates an embodiment of an environment in which machine data collection and analysis is performed. In this example, data collection and analysis platform 102 (also referred to herein as the “platform” or the “system”) is configured to ingest and analyze machine data (e.g., log messages and metrics) collected from customers (e.g., entities utilizing the services provided by the data collection and analysis platform 102). For example, collectors (e.g., collector/agent 104 installed on machine 106 of a customer) send log messages to the platform over a network (such as the Internet, a local network, or any other type of network, as appropriate); customers may also send logs directly to an endpoint such as a common HTTPS endpoint. Collectors can also send metrics, and likewise, metrics can be sent in common formats to the HTTPS endpoint directly. In some embodiments, metrics rules engine 144 is a processing stage (that may be user guided) that can change existing metadata or synthesize new metadata for each incoming data point.

As used herein, log messages and metrics are but two examples of machine data that may be ingested and analyzed by the data collection and analysis platform 102 using the techniques described herein. Collector/Agent 104 may also be configured to interrogate machine 106 directly to gather various host metrics such as CPU (central processing unit) usage, memory utilization, etc.

Machine data, such as log data and metrics, are received by receiver 108, which, in one example, is implemented as a service receiver cluster. Logs are accumulated by each receiver into bigger batches before being sent to message queue 110. In some embodiments, the same batching mechanism applies to incoming metrics data points as well.

The batches of logs and metrics data points are sent from the message queue to logs or metrics determination engine 112. Logs or metrics determination engine 112 is configured to read batches of items from the message queue and determine whether the next batch of items read from the message queue is a batch of metrics data points or whether the next batch of items read from the message queue is a batch of log messages. For example, the determination of what machine data is log messages or metrics data points is based on the format and metadata of the machine data that is received.

In some embodiments, a metadata index (stored, for example, as metadata catalog 142 of platform 102) is also updated to allow flexible discovery of time series based on their metadata. In some embodiments, the metadata index is a persistent data structure that maps metadata values for keys to a set of time series identified by that value of the metadata key.

For a collector, there may be different types of sources from which raw machine data is collected. The type of source may be used to determine whether the machine data is logs or metrics. Depending on whether a batch of machine data includes log messages or metrics data points, the batch of machine data will be sent to one of two specialized backends, metrics processing engine 114 and logs processing engine 124, which are optimized for processing log messages and metrics data points, respectively.

When the batch of items read from the message queue is a batch of metrics data points, the batch of items is passed downstream to the metrics processing engine 114. The metrics processing engine 114 is configured to process metrics data points, including extracting and generating the data points from the received batch of metrics data points (e.g., using data point extraction engine 116). Time series resolution engine 118 is configured to resolve the time series for each data point given data point metadata (e.g., metric name, identifying dimensions). Time series update engine 120 is configured to add the data points to the time series (stored in this example in time series database 122) in a persistent fashion.

If logs or metrics determination engine 112 determines that the batch of items read from the message queue is a batch of log messages, the batch of log messages is passed to logs processing engine 124. Logs processing engine 124 is configured to apply log-specific processing, including timestamp extraction (e.g., using timestamp extraction engine 126) and field parsing using extraction rules (e.g., using field parsing engine 128). Other examples of processing include further augmentation (e.g., using logs enrichment engine 130).

The ingested log messages and metrics data points may be directed to respective log and metrics processing backends that are optimized for processing the respective types of data. However, there are some cases in which information that arrived in the form of a log message would be better processed by the metrics backend than the logs backend. One example of such information is telemetry data, which includes, for example, measurement data that might be recorded by an instrumentation service running on a device. In some embodiments, telemetry data includes a timestamp and a value. The telemetry data represents a process in a system. The value relates to a numerical property of the process in question. For example, a smart thermostat in a house has a temperature sensor that measures the temperature in a room on a periodic basis (e.g., every second). The temperature measurement process therefore creates a timestamp-value pair every second, representing the measured temperature of that second.

Telemetry may be efficiently stored in, and queried-from, a metrics time series store (e.g., using the metrics processing engine 114) than by abusing a generic log message store. By doing so, customers utilizing the data collection and analysis platform 102 can collect host metrics such as CPU usage directly using, for example, a metrics collector. In this case, the collected telemetry is directly fed into the optimized metrics time series store (e.g., provided by the metrics processing engine 114). The system can also at the collector level interpret a protocol, such as the common Graphite protocol, and send it directly to the metrics time series storage backend.

As another example, consider a security context, in which syslog messages may come in the form of CSV (comma separated values). However, storing such CSV values as a log would be inefficient, and it should be stored as a time series in order to better query that information. In some example embodiments, although metric data may be received in the form of a CSV text log, the structure of such log messages is automatically detected, and the values from the text of the log (e.g., the numbers between the commas) are stored in a data structure such as columns of a table, which better allows for operations such as aggregations of table values, or other operations applicable to metrics that may not be relevant to log text.

The logs-to-metrics translation engine 132 is configured to translate log messages that include telemetry data into metrics data points. In some embodiments, translation engine 132 is implemented as a service. In some embodiments, upon performing logs to metrics translation, if any of the matched logs-to-metrics rules indicates that the log message (from which the data point was derived) should be dropped, the log message is removed. Otherwise, the logs processing engine is configured to continue to batch log messages into larger batches to persist them (e.g., using persistence engine 134) by sending them to an entity such as Amazon S3 for persistence.

The batched log messages are also sent to log indexer 136 (implemented, for example, as an indexing cluster) for full-text indexing and query update engine 138 (implemented, for example, as a continuous query cluster) for evaluation to update streaming queries.

In some embodiments, once the data points are created in memory, they are committed to persistent storage such that a user can then query the information. In some embodiments, the process of storing data points includes two distinct parts and one asynchronous process. First, based on identifying metadata, the correct time series is identified, and the data point is added to that time series. In some embodiments, the time series identification is performed by time series resolution engine 118 of platform 102. Secondly, a metadata index is updated in order for users to more easily find time series based on metadata. In some embodiments, the updating of the metadata index (also referred to herein as a “metadata catalog”) is performed by metadata catalog update engine 140.

Thus, the data collection and analysis platform 102, using the various backends described herein, is able to handle any received machine data in the most native way, regardless of the semantics of the data, where machine data may be represented, stored, and presented back for analysis in the most efficient way. Further, a data collection and analysis system, such as the data collection and analysis platform 102, has the capability of processing both logs and time series metrics, provides the ability to query both types of data (e.g., using query engine 152) and creates displays that combine information from both types of data visually.

The log messages may be clustered by key schema. Structured log data is received (it may have been received directly in structured form, or extracted from a hybrid log, as described above). An appropriate parser consumes the log, and a structured map of keys to values is output. All of the keys in the particular set for the log are captured. In some embodiments, the values are disregarded. Thus, for the one message, only the keys have been parsed out. That set of keys then goes into a schema which may be used to generate a signature and used to group the log messages. That is, the signature for logs in a cluster may be computed based on the unique keys the group of logs in the cluster contains. The log is then matched to a cluster based on the signature identifier. In some embodiments, the signature identifier is a hash of the captured keys. In some embodiments, each cluster that is outputted corresponds to a unique combination of keys. In some embodiments, when determining which cluster to include a log in, the matching of keys is exact, where the key schemas for two logs are either exactly the same or different.

In some embodiments, data point enrichment engine 146 and logs enrichment engine 130 are configured to communicate with metadata collection engine 148 in order to obtain, from a remote entity such as third party service supplier 150, additional data to enrich metrics data points and log messages, respectively.

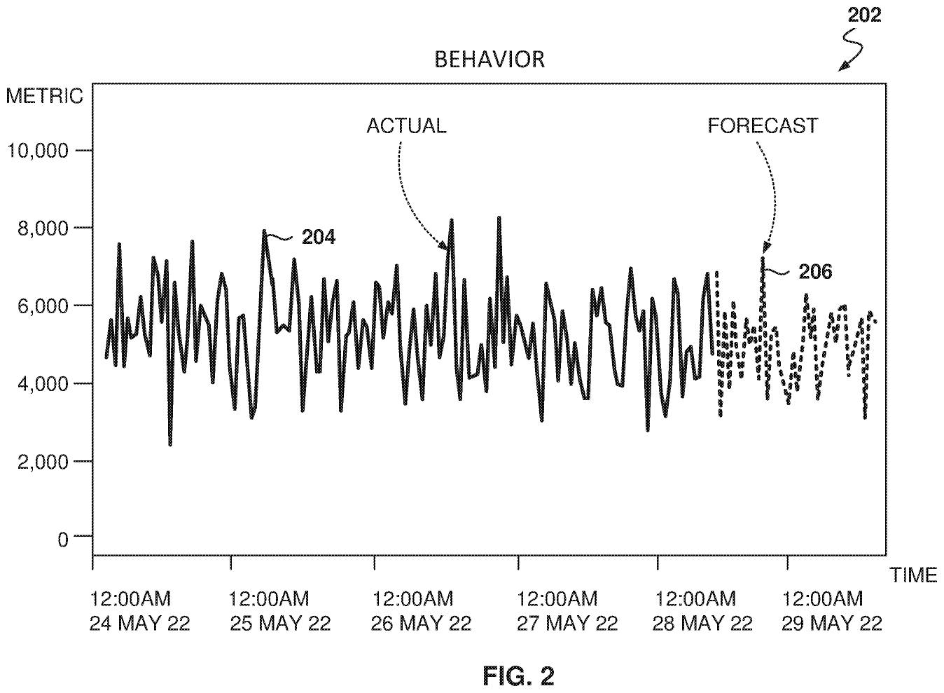

FIG. 2 is a chart 202 showing the behavior of a metric over time and the forecast value for the future, according to some example embodiments. The chart 202 shows how the metric values (vertical axis) change over time (horizontal axis) and includes an actual line 204 for the values of the metric actually collected, and a forecast line 206 that shows the forecasted values predicted after a certain time.

The metric can be from many different types, such as CPU utilization, memory usage, number of users on the system, a number of virtual machines, hard drive access, temperature in a data center, power consumption on the data center, number of logins, etc.

In some example embodiments, the forecasted data is calculated using ML models that estimate the future based on the historical data. For example, the model is trained using training data obtained during the most recent three months, and the forecasted data covers the following week. However, other time periods may be used.

Forecasts can be useful for several reasons. The user may want to know what are the business requirements for the near future, so the user can provision hardware and software resources appropriately. Another good reason for forecasting is to determine if a resource associated with the metric is not behaving properly, which could be a reason for concern, that is, an anomaly that needs to be addressed.

A robust estimator has to estimate accurately even if a small fraction of the training data is corrupted or covers a time where the system was not behaving properly. For example, taking the metric average may not be robust because if the average of the height of 100 people is being calculated, but someone enters the wrong number like a million meters, then the average would be completely distorted just because of one wrong data point. However, for the same scenario, the median value of the heights would not be as distorted because one outlier value will not significantly modify the median value.

Therefore, it is important to use robust estimators (e.g., prediction models) that can accurately predict future values without being affected by outliers in the training data.

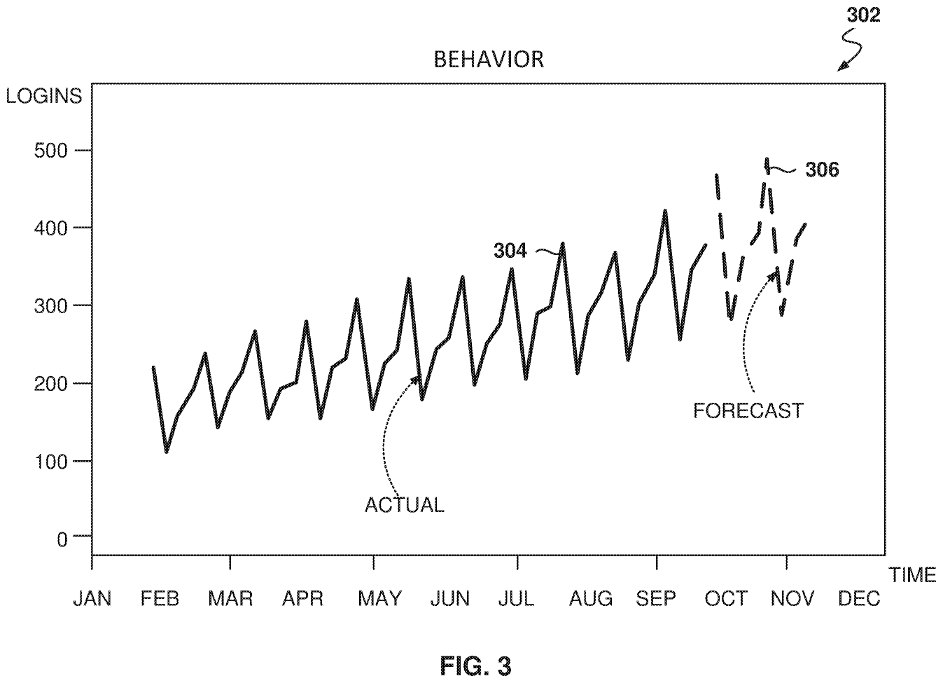

FIG. 3 is a chart 302 showing forecasting metric behavior accounting for trends in the metric data, according to some example embodiments. In this example, the chart is for the number of user logins in the system. As in FIG. 2, actual line 304 represents the actual number of logins and forecast line 306 represents the forecasted values for the future.

A good forecasting model takes into account seasonalities present in the data. The actual line 304 shows how the data goes up and down in a repeated pattern lasting about three weeks. Also, it can be observed in the actual line 304 that there is a growth pattern on the moving average of the actual line 304.

In some example embodiments, different kinds of models with different configurations may be used to make the predictions. Different metrics will be better forecasted with different models and different configurations (e.g., hyperparameters), so it is important to determine which model and which configuration is best suited for the metric. For example, hyperparameters may be configured to set smoothing factors for the model. Some examples of forecasting models include Auto-Regressive (AR) model, Moving Average (MA) model. Auto Regressive Moving Average (ARMA) model, Auto-Regressive Integrated Moving Average (ARIMA) model, Seasonal Auto-Regressive Integrated Moving Average (SARIMA) model, Holt Winters, Bayesian time-series analysis, Gaussian processes, Dynamic Deep Learning, etc.

One goal is to find a forecasting model with high-fidelity to the historical data that is able of capturing inter-day and intraday seasonality behaviors. Tor example, a SaaS platform in various geographies may show usage peaks during the nine-to-five workday and also higher Monday through Friday than on the weekend, so there are two levels of seasonality happening.

Embodiments provided perform a search to get a predictive forecasting model that indeed accurately captures whatever seasonalities or patterns are present in the normal operating behavior of the data.

The illustrated example in FIG. 3 is for an estimate calculated using the Holt Winters method. The Holt Winters method, also referred to as the Holt-Winters' seasonal method, is a forecasting method for capturing seasonality, and it uses three smoothing equations, one for the level, one for the trend, and the last one for the seasonal component. These smoothing equations have corresponding smoothing parameters.

There are two variations to the Holt-Winters method that differ in the nature of the seasonal component. A first variation is an additive method, which is preferred when the seasonal variations are roughly constant through the series. The second variation is the multiplicative method, preferred when the seasonal variations are changing proportional to the level of the series. The type of method may be used as another type of hyperparameter that can be tuned.

As seen in FIG. 3, the forecast line 306 shows both seasonality patterns for the periodic up-and-down pattern as well as the growing moving average value.

Another method is Bayesian inference, which is a forecasting method that performs robust modelling even in highly uncertain situations. It allows for the inclusion of measures of uncertainty, e.g., to actively select where and when to observe samples, and offers approaches to combine information from multiple noisy sources.

Bayesian inference uses time-series analysis into the format of a regression problem, of the form y(x)=f(x)+n, in which function f( ) is a (typically) unknown function and n is a (typically white) additive noise process. The goal of inference in such problems is twofold: firstly to evaluate the putative form of f( ) and secondly to evaluate the probability distribution of y for some x (i.e., p(y|x)).

Gaussian Processes (GP) are a generic supervised learning method designed to solve regression and probabilistic classification problems. The advantages of Gaussian processes include the prediction interpolates the observations (at least for regular kernels), the prediction is probabilistic (Gaussian) so that one can compute empirical confidence intervals and decide based on those if one should refit (online fitting, adaptive fitting) the prediction in some region of interest, and is versatile, where different kernels can be specified. Common kernels are provided, but it is also possible to specify custom kernels.

The disadvantages of Gaussian processes include that they are not sparse, and they lose efficiency in high dimensional spaces—namely when the number of features exceeds a few dozens.

CUmulative SUM (CUSUM) control chart is typically used for monitoring change detection. When the CUSUM method is applied to changes in mean, it can be used for step detection of a time series.

It is noted that the embodiments models described above are examples and do not describe every possible embodiment. Other embodiments may utilize different models with different configurations.

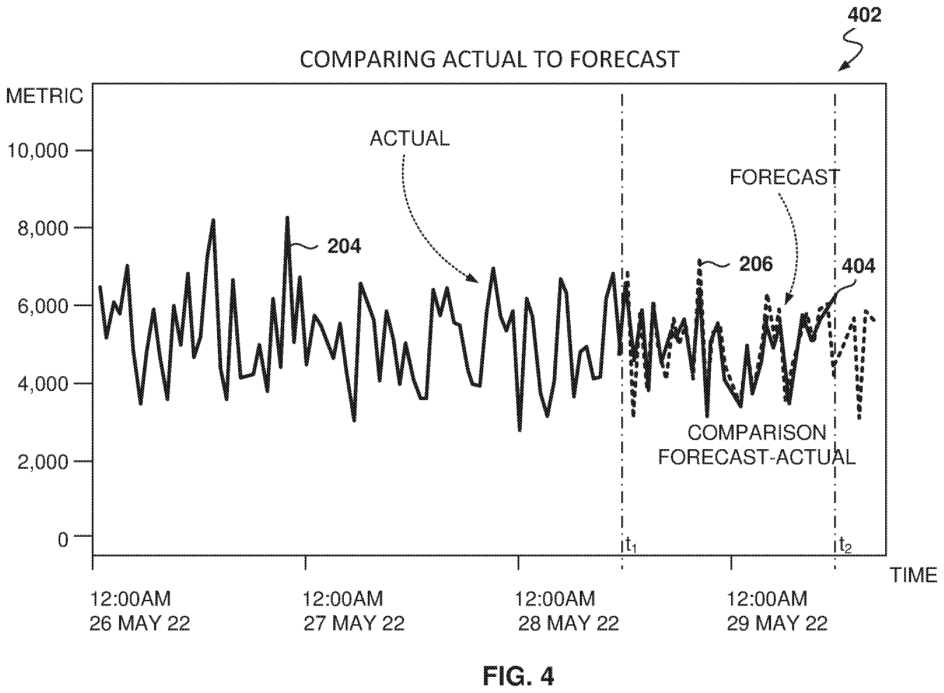

FIG. 4 shows a chart 402 comparing actual versus forecasted data, according to some example embodiments. At time t₁, a forecast was made as shown in the forecast line 206. After t₁, the actual performance 404 is captured and presented in the chart 402, up to the current time of t₂.

In this illustrated example, it is easily observed that the actual performance after t₁ matches the forecast previously made. This is an indication that the system is acting appropriately, so no anomaly should be detected.

However, if the actual and the forecast diverge in a substantial manner, this can be a sign that an anomaly in the system has occurred, e.g., the response time for accessing a resource is well below the predicted value for the period. Based on this divergence, the system can generate an alarm and flag that a problem has occurred or may be occurring. Additional analysis may be performed on the data, and other related metrics, to investigate possible reasons for the divergence.

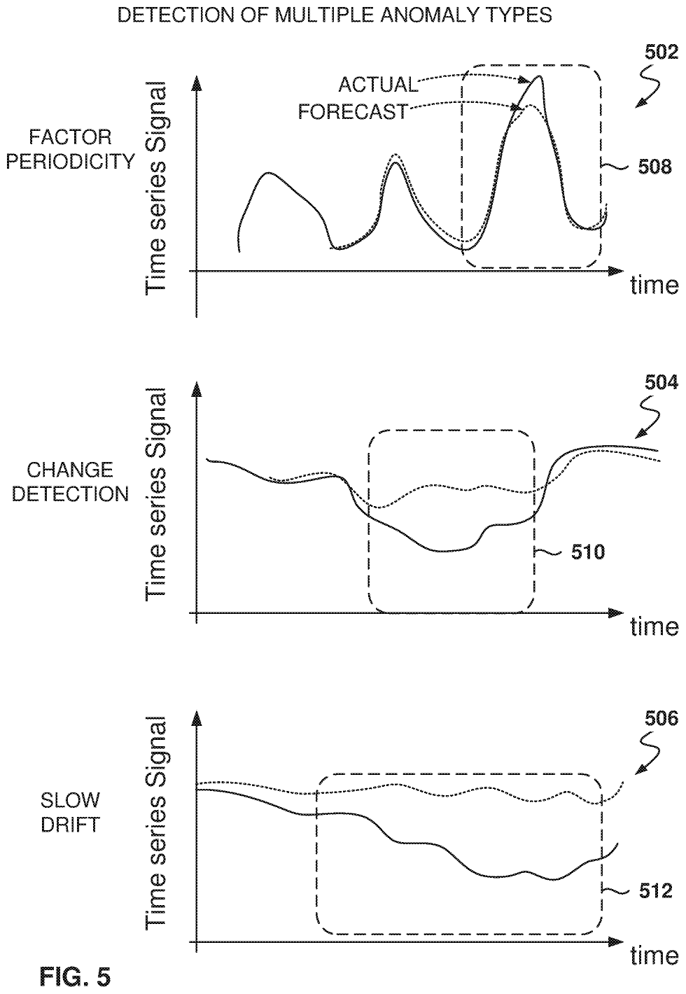

FIG. 5 illustrates anomaly types. In general, the behavior of a metric is forecasted and then compared to the actual values that take place. When the actual diverges from the forecast, then an anomaly is flagged and an alert generated.

In some example embodiments, an option is provided to users for customizing the types of anomaly detectors of interest, that is, the types of anomalies that will generate alerts. For example, if the user is interested in persistent deviations from forecast but not interested in transient spikes, then the UI provides options for selecting which anomalies create alerts and which anomalies can be ignored.

Chart 502 shows a time series signal with factor periodicity, similar to the chart 302 of FIG. 3. In this case, the forecast shows the peaks and valleys similar to the actual, except that the last peak on the right shows a problem area 508 where the peak is higher than the prediction.

However, the system or the user may define rules for determining when an anomaly has taken place based on the variance between actual and forecasted. For example, a percentage threshold may be identified and if the actual differs from the forecast more than the percentage threshold (e.g., up, or down, or both, depending on the metric), then the anomaly is flagged in the form of an alert. In the illustrated example, the variance from forecast may be marked as an anomaly or not, depending on the configured threshold.

Chart 504 shows an example of a time series signal with change detection. The problem area 510 shows a divergence where the actual dips below the forecasted value by a substantial amount, about half of the predicted value in some places. An anomaly would be reported because of the substantial change of the actual metric.

Chart 506 show an example of a time series signal with a slow drift. Problem area 512 shows how the actual value of the metric drifts lower for a substantial amount of time.

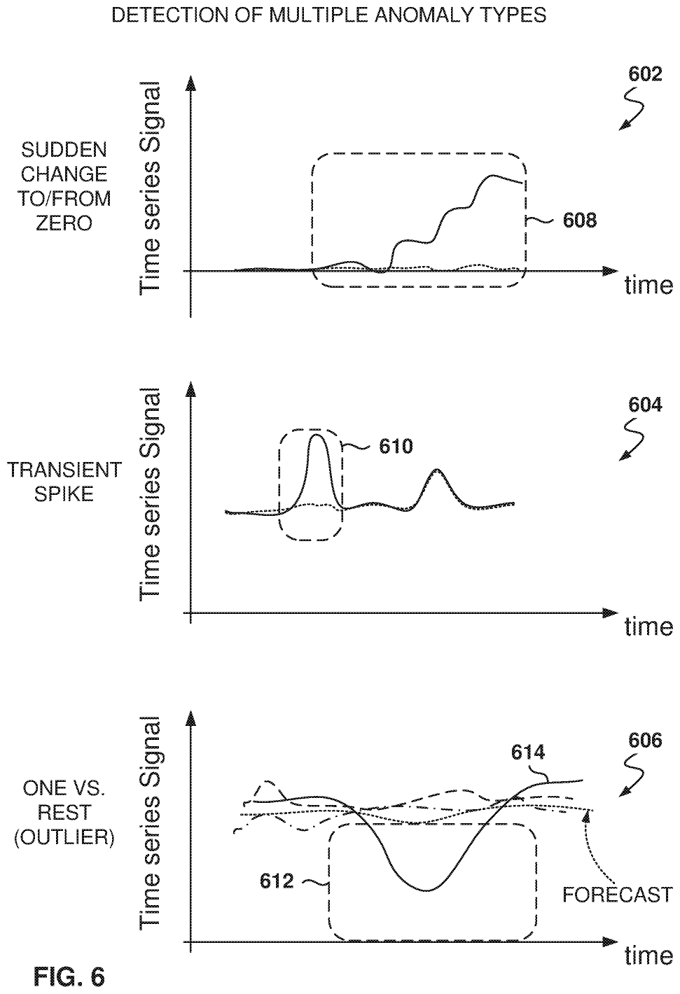

FIG. 6 illustrates additional anomaly types. Chart 602 shows a problem area 608 where the signal that is forecasted to stay around the zero value has a gradual increase. The anomaly detected would show the departure of the actual value from the forecast.

Chart 604 shows a problem area 610 where the time series signal shows a transient spike from the forecasted value that is forecasted to be substantially constant. The anomaly detector would flag the spike as a potential problem.

Check 606 illustrates a plurality of time series signal that are related. For example, the signals may all relate to CPU utilizations in a host computer and the expectation is that the CPU utilizations would be similar. Another example would be for a plurality of working nodes working together within a pod, where the performance of the working nodes is expected to be similar.

The chart 606 shows the forecast value for all the metrics and the behaviors of the actual values for the metrics. Line 614 shows the value for one of the metrics, and area 612 shows how line 614 has a dip in value when compared to the forecast line, as well as compared to the other similar metrics. The anomaly would indicate that one of the metrics is an outlier when compared to the other similar metrics.

Current approaches for detecting anomalous behavior typically require configuring each metric by setting rules on what is the anomaly condition. But in a system with thousands of metrics, this may be an impossible task trying to monitor all these metrics.

For example, there may be a system that uses multiple upstream services. There may be a problem with one of the downstream services provided by the system, so the assumption would be that the system is malfunctioning. However, change detection may also detect that something broke in one of the upstream services that the system relies upon, so troubleshooting would shift from focusing on the system to focusing on the upstream services.

With the new approach to anomaly detection, each metric may be automatically tracked, forecasted, and analyzed to detect anomalies with none or minimal input from the user. This is particularly helpful in security applications to be able to quickly detect possible attacks when any of the metrics show an unexpected behavior.

The change-detection approach can be used to add any type of detector, or many of them, to check what is happening in the environment, resulting in improved troubleshooting that can cut the amount of time needed to solve a problem substantially.

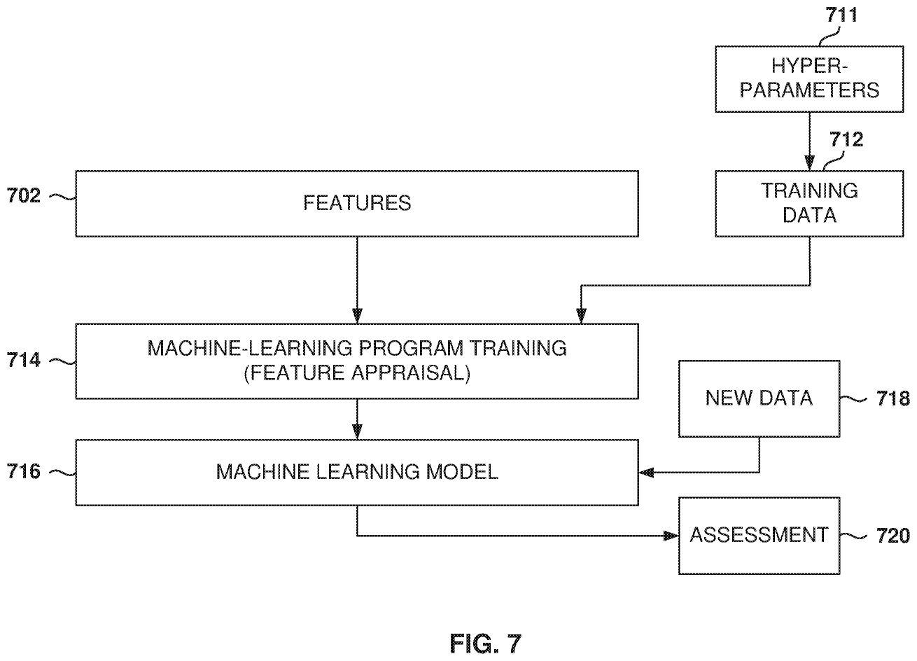

FIG. 7 illustrates the training and use of a machine-learning model, according to some example embodiments. In some example embodiments, machine-learning (ML) models 716, are utilized to forecast the behavior of a metric, e.g., a metric tracked as a time-series signal.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 716 from example training data 712 in order to make data-driven predictions or decisions expressed as outputs or assessments 720. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML model 716 provide prediction of the behavior of a metric for a defined period of time. For example, the ML model 716 provides a plurality of values for a time series that cover the period of time (e.g., one day, one week, one month).

The training data 712 comprises examples of values for the features 702. In some example embodiments, the training data comprises labeled data with examples of values for the features 702 (e.g., timestamp, metric value). The machine-learning algorithms utilize the training data 712 to find correlations among identified features 702 that affect the outcome. A feature 702 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 702 may be of different types and may include timestamps and corresponding values of the metric for a predefined period. In other embodiments, two or more metrics may be analyzed together and the training data will include the values for the two or more metrics.

During training 714, the ML program, also referred to as ML algorithm or ML tool, analyzes the training data 712 based on identified features 702 and hyperparameters 711 defined for the training. The result of the training 714 is the ML model 716 that is capable of taking inputs to produce assessments.

The ML algorithms usually explore many possible functions and parameters before finding what the ML algorithms identify to be the best correlations within the data; therefore, training may make use of large amounts of computing resources and time.

Many ML algorithms include hyperparameters 711, and the more complex the ML algorithm, the more parameters there are that are available to the user. The hyperparameters 711 define variables for an ML algorithm in the search for the best ML model. The training parameters include model parameters and hyperparameters. Model parameters are learned from the training data, whereas hyperparameters are not learned from the training data, but instead are provided to the ML algorithm.

Some examples of model parameters include maximum model size, maximum number of passes over the training data, data shuffle type, regression coefficients, decision tree split locations, and the like. Hyperparameters may include the number of hidden layers in a neural network, the number of hidden nodes in each layer, the learning rate (perhaps with various adaptation schemes for the learning rate), the regularization parameters, types of nonlinear activation functions, and the like. Finding the correct (or the best) set of hyperparameters can be a very time-consuming task that makes use of a large amount of computer resources.

When the ML model 716 is used to perform an assessment, new data 718 is provided as an input to the ML model 716, and the ML model 716 generates the assessment 720 as output. For example, a time period may be entered as an input and the ML model 716 will generate predictions for the metric over that time period. In other embodiments, a time may be entered as the input and the ML model 716 will generate the prediction for that time.

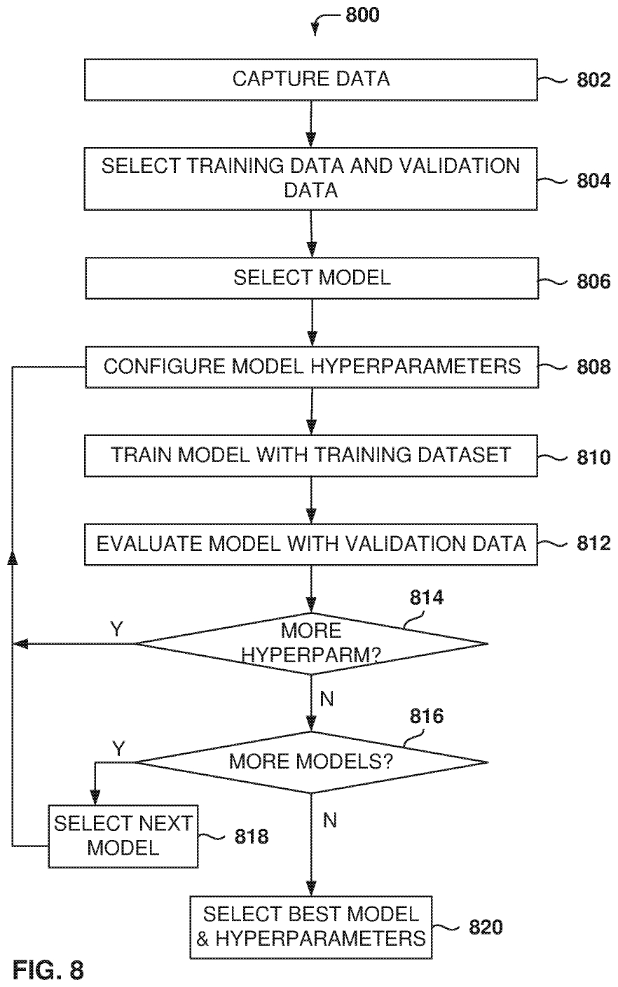

FIG. 8 is a flowchart of a method 800 for selecting the best forecasting model for a metric, according to some example embodiments. While the various operations in this flowchart are presented and described sequentially, one of ordinary skill will appreciate that some or all of the operations may be executed in a different order, be combined or omitted, or be executed in parallel.

Different types of data may present different types of behaviors, which may be better forecasted by different models. For example, some metrics may be very linear in nature, so simple models may be adequate. However, other metrics may incorporate seasonalities so a more complex model that can predict seasonalities is required. This is why checking the models with different configurations is important to determine the best forecaster model possible.

Additionally, there is a factor of resource consumption, so a simpler model that is a good predictor for a metric may be chosen over another more complex model that offers slightly better forecasting but that requires many more resources for training and inferencing.

At operation 802, the data for a metric is captured. The data may be captured via logs or metric messages captured by the metrics processing engine 114. For example, the data may include data for one or more time series, each time series corresponding to the values for the metric being forecasted.

From operation 802, the method 800 flows to operation 804 where some of the captured data is selected to become the training data that will be used to train the models and the validation data used to assess the accuracy of models and hyperparameters being tested. For example, the captured data for the most recent three months is selected for the training data and the validation data. Typically, most of the data is used for training (e.g., 80%) and the remaining for validation (e.g., 20%) but other ratios are also possible.

In one example embodiment, the captured data includes a dataset consisting of 48 hours of averaged cluster CPU utilization from a system deployment over a period of two days with a granularity of 5 minutes. The first 24 hours of the captured data is selected for the training data and the last 24 hours are selected as the validation data.

In some example embodiments, the historical data that covers an anomaly period is not used for training or validation. The goal is to predict a system behaving correctly, so including the anomaly period may result in deviations from the expected behavior of a system operating correctly. Thus, the data from anomaly periods is discarded for training purposes in order to obtain robust estimating models.

The time period for the training data should be able to cover enough time to be able to capture the seasonalities of the data, such as the ones described in FIG. 3. If the training data would cover only a “valley” period of a metric with peaks and valleys, then the occurrence of normal high values of the metric would appear as anomalies. Thus, it is important for the metrics processing engine 114 to store enough data for accurate prediction (e.g., at least three months, six months, a year). In current systems, historical metric data tend to have little value after a short time, such as a week, because problem investigation tends to focus on changes between recent past behavior and the anomaly behavior period. Thus, the metrics processing engine 114 has to allocate enough resources to keep the time-series values for longer periods of time in order to use this data for training forecasting models.

From operation 804, the method 800 flows to operation 806 where a model is selected. In some example embodiments, a plurality of models are available for evaluation, and each model may have hyperparameters to be configured. The goal is to find the best model and the best hyperparameters combination that offers the best forecasting accuracy for each metric.

There could be several models available; thus, the choice of model becomes one of the parameters to be optimized for forecasting the metric. It is noted that the choice of model for a metric may change over time, because the metric behavior changes, because some models may improve forecasting capabilities, or because of the appearance of new and better forecasting models.

From operation 806, the method 800 flows to operation 808 to configure the hyperparameters for the selected model. Finding a prediction model for univariate time series data can be a complicated process due to the vast library of prediction models available (e.g., LR, AR, ARIMA, SARIMA), and because the number of dimensions and hyperparameters that need to be specified before fitting the model (e.g., the order parameters of SARIMA). To abstract this process of picking and choosing models, a framework is provided to automatically make these decisions based on user data.

For example, AR is a basic model and AR has one hyperparameter called Lags, which is the number of historical data points used to make predictions. In some example embodiments, the partial auto-covariance function (PACF) of the data is estimated, and the highest non-zero 6 spikes that are above the standard deviation of the 95% confidence interval are selected.

The SARMA model is more complex. In some example embodiments, seven different parameters are considered:
1. p is the trend autoregressive order. The method estimates the partial auto-covariance function (PACF) of the data and selects the highest non-zero 12 spikes that are above the standard deviation of the 95% confidence interval.
2. d is the trend difference order that determines whether to look at the raw time series of the difference between data points instead. Values selected are 0 or 1.
3. q is the trend moving average order. The method estimates the auto-covariance function (ACF) of the data and selects the highest non-zero 12 spikes that are above the standard deviation of the 95% confidence interval.
4. m is the number of time steps for a single seasonal period and determines the lowest periodicity of the time series. In some example embodiments, the lowest common denominators of at least three spikes in the PACF estimation and ACF estimate are selected. For example, if [1, 12, 24, 36] are spikes in PACF and ACF, then 12 is the only LCD that satisfies this condition.
5. P is the Seasonal autoregressive order. Values selected are 0 or 1.
6. D is the seasonal differencing order. Values selected are 0 or 1.
7. Q is the seasonal moving average order. Values selected are 0 or 1.

In some example embodiments, the forecaster system, also referred to herein as AutoML, uses the Tree-structured Parzen Estimator (TPE) sampler in Optuna with 16 trials to decide the best model type to use for the data (e.g., AR and SARIMA) and to find the best hyperparameters to use for the model out of a candidate pool of hyperparameters.

Given the large number of variations, in some cases, a grid search may be used to narrow the selection for hyperparameter selection. At a high level, in a seven-dimensional space, values of hyperparameters that are similar will produce similar accuracy, so moving around the grid in the seven-dimensional space is a good way to explore the hyperspace and converge to the right values fast.

In existing solutions, to train a model that can make predictions, the user is required to manually enter values for the hyperparameters, train the model, and then check the accuracy of the resulting model. If the resulting model has low accuracy, the user has to reenter new hyperparameter values and perform the training again. Then check the accuracy again and repeat the process until the adequate accuracy is achieved. This could be a long and hard process, especially when the number of hyperparameters is big (e.g., seven) given all the possibilities.

In other approaches, typically, the user guesses values for the hyperparameters, which may be very difficult, especially if the user is not a modeling expert. This is different from the presented approach for a systematic search of the best values for the hyperparameters. The current embodiments provide a solution for automatic hyperparameter tuning without requiring the user to configure the hyperparameter values, which is a great time saver and allows for the exploration of more hyperparameter configurations since manual configuration tends to be limited to a few tries. However, in some embodiments, an option is provided for the user to configure the hyperparameters, or at least provide an initial value for the search, which may be useful in cases where the user has already experience with the modeling.

In some example embodiments, the Parzen Windows density estimation technique is used to explore values for the hyperparameters. Parzen Window is a non-parametric density estimation technique. Density estimation in pattern recognition can be achieved by using the approach of the Parzen Windows. Parzen window density estimation technique is a kind of generalization of the histogram technique, and is used to derive a density function {f(x)} used to implement a Bayes Classifier. Further, {f(x)} takes sample input data value and returns the density estimate of the given data sample.

In some example embodiments, the tool Optuna is used. Optuna is an automatic hyperparameter optimization software framework, particularly designed for machine learning. Optuna is a framework designed for the automation and the acceleration of the optimization studies. Optuna features an imperative, define-by-run style user API. The code written with Optuna enjoys high modularity, and the user of Optuna can dynamically construct the search spaces for the hyperparameters.

Optuna uses the terms study and trial. Study refers to an optimization based on an objective function, and trial refers to a single execution of the objective function. The goal of a study is to find out the optimal set of hyperparameter values through multiple trials (e.g., number of trials=100).

Optuna then determines the optimal model type and hyperparameters by selecting the configurations which minimize the Akaike Information Criterion (AIC), which is a standard criterion that tries to promote models that minimize the RMSE whilst penalizing the number of parameters the model contains.

From operation 808, the method 800 flows to operation 810, where the selected model is trained with the selected training data and the configured values for the hyperparameters.

From operation 810, the method 800 flows to operation 812 where the model obtained at operation 810 is evaluated using the validation data set aside at operation 804.

From operation 812, the method 800 flows to operation 814 to check if there are more hyperparameters that need to be tested. The check may be based on the accuracy of the model so far, the maximum number of passes, and if there are any other hyperparameter values to be tested. If there are more hyperparameters to be tested, the method 800 flows back to operation 808, and if there are no more hyperparameters to be tested, the method 800 flows to operation 816.

At operation 818, a check is made to determine if there are more models to be tested. If there are more models to be tested, the method 800 flows back to operation 818 to select the next model, and then back to operation 808. If there are no more models to be tested, the method 800 flows to operation 820.

At operation 820, the combination of model and hyperparameters that produced the best accuracy are selected to forecast the behavior of the metric.

The process of selecting the model is repeated periodically (e.g., weekly, monthly) to account for changes in the underlying behaviors of the metrics. Also, the models may be improved or additional modules may be used and considered. Additionally, the training and validation data will change as more recent data will be used.

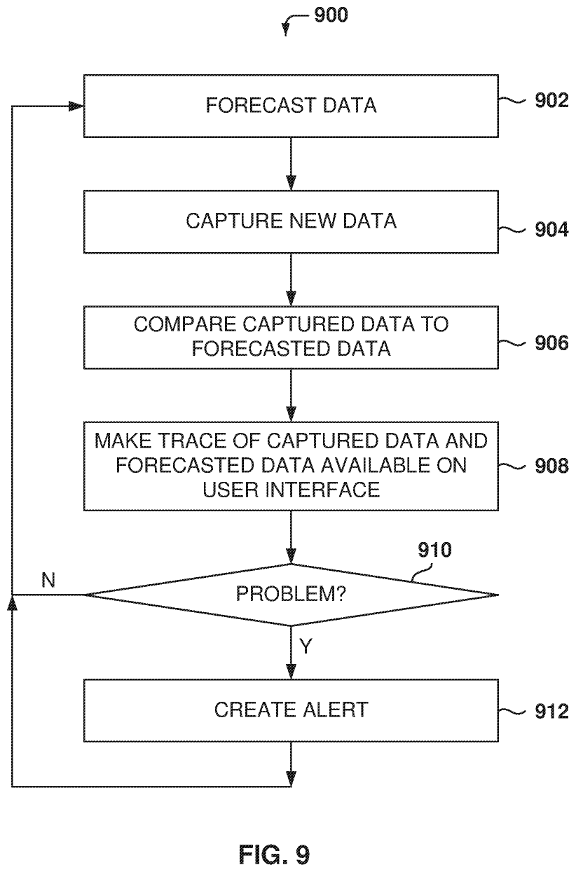

FIG. 9 is a flowchart of a method 900 for detecting problems based on the forecasted data, according to some example embodiments. While the various operations in this flowchart are presented and described sequentially, one of ordinary skill will appreciate that some or all of the operations may be executed in a different order, be combined or omitted, or be executed in parallel.

The anomaly detection process is broken into two mayor components, selection of the forecasting model (as described above with reference to FIG. 8), and the detection of anomalies utilizing the forecasting models. The two components are separated, so the selection process does not affect the outcome of the anomaly detection. For example, new models may be selected and the new models would work the same way as the other models during the detection phase. The anomaly detection phase includes interpreting and detecting the gap deviations between actual and predicted behavior.

Different engineering teams be work in parallel for improving forecasts and improving anomaly detection with almost complete independence, which simplifies the development process considerably.

At operation 902, the data is forecasted by utilizing the selected model and inputting the selected data range for the forecast. In some example embodiments, the input to the model is a timestamp and the output is the value forecasted for that time; therefore, the model is invoked multiple times for the desired forecasted time range. In other embodiments, the input is a time range and the output of the model is a time series for the values for the metric for that time period.

From operation 902, the method 900 flows to operation 904 where new data is captured. The data capture corresponds to the time previously forecasted.

From operation 904, the method 900 flows to operation 906 to compare the captured data with the forecasted data in the search for potential anomalies. The goal is to use the forecast to identify time-series anomalies by determining that, during some period, the actual deviated substantially from the prediction.

From operation 906, the method 900 flows to operation 908, which is optional in some embodiments, to make the trace of the captured data and the forecasted data available on the user interface, enabling the user to visually check the deviations of the actual from the expected behavior.

For example, options may be presented to view the logs for the anomaly period, check a comparison with other selected metrics, go to a metric-search UI, or to a trace-search UI, etc. The user is able to interact with the raw telemetry data.

Additionally, the anomaly may be assigned to an incident, so when the user investigates the incident, the anomaly provides a clue on what could have gone wrong. For example, the anomaly may be correlated to an incident that happened after a new code release was introduced into production, so the anomaly, or anomalies, may provide indications of where things may have gone wrong.

From operation 908, the method 900 flows to operation 910 to determine if a problem or anomaly is detected. In some example embodiments, a duration threshold and a divergence threshold are used to detect problem or anomalies. To determine that a problem has occurred, the difference between the forecast and the actual has to be above or below (depending on the metric) the threshold divergence for at least the duration threshold (which may be zero). The threshold divergence may be measured as an absolute value or as a percentage value.

Further, in some metrics, the problem is ascertained if the actual is above the forecast, but not if it is below (e.g., an alarm will not be triggered if the CPU utilization is lower than expected). For all the metrics, the opposite criteria may be used (e.g., an alarm will not be triggered if the network throughput of a router is above the forecasted value).

Other embodiments may utilize other criteria to determine when a problem occurs, such as calculating moving averages of the differences between actual and factual. Which criteria is used may be automatically assigned based on the type of metric (e.g., CPU utilization, amount of free memory, number of logins, shopping carts lost, queue size).

In some example embodiments, deviations from normal are also flagged for the user, even though they may not be the cause of a problem. This is useful for users to understand when the system is behaving differently than expected, which may help identify emerging problems before the problems become disasters.

If a problem or deviation is identified, the method 900 flows to operation 912. If no problem is identified, the method 900 flows back to operation 902 to keep monitoring incoming data.

At operation 912, an alert is generated to notify the user that a potential problem is occurred. The user may then use all the tools of the analysis platform 102 to investigate, including the UI that presents the difference between forecast and actual.

The alert provides proactive alerts that may be trigger before malfunction of the system. Many current problem-detection systems today help in detecting isolated, acute resource-utilization spikes, but are poor at detecting sustained change. The current embodiments address this problem by addressing the potential gradual degradation of a resource.

Further, tools are provided to the user to select which types of anomalies should be reported. The user may configure the type of anomaly that is interesting, while discarding variations of metrics that are not interesting.

Besides flagging for the user or alerting, in some example embodiments, the anomalies are as used as information by the analysis platform 102 for further analysis and correlation with other events. That is, anomalies detected based on deviations from forecast can themselves be the subject of additional programmatic or algorithmic analysis and correlation to identify higher-level patterns of behavior, determine problem root causes, etc.

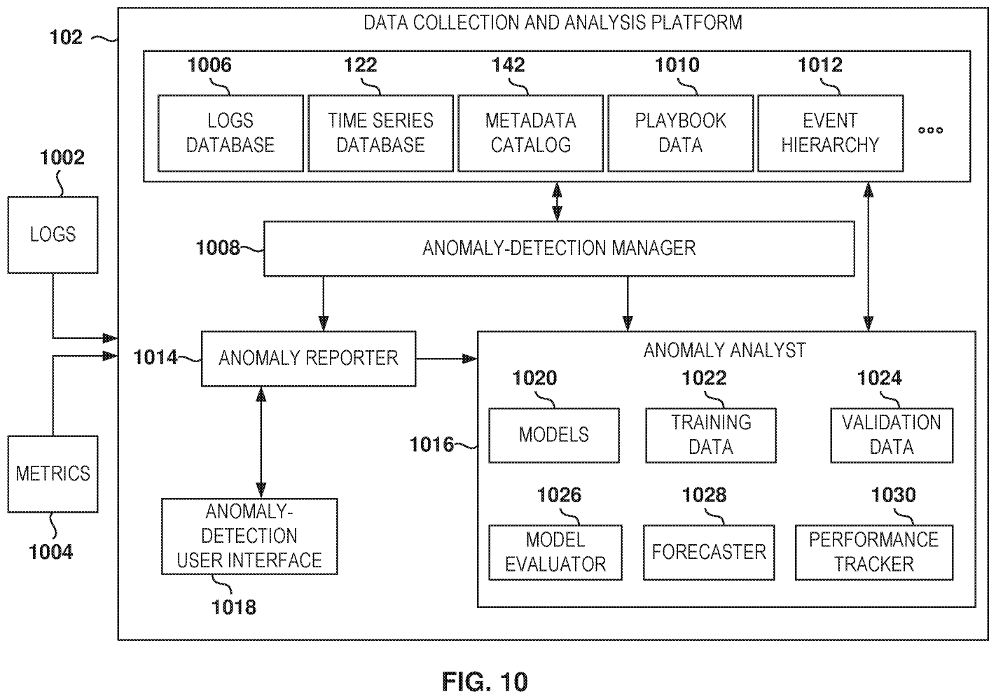

FIG. 10 is an architecture for a problem-detection tool, according to some example embodiments. The data collection and analysis platform 102 continuously collects information (log data 1002 or metrics data 1004) and analyzes, classifies, and stores the information. Another type of source data may include traces (not shown). For example, the data collection and analysis platform 102 stores the data in the logs database 1006, time series database 122, and metadata catalog 142. Further, the signatures of incoming logs are analyzed to generate playbook data 1010, event hierarchy data 1012, etc.

The incoming log data 1002 and metrics data 1004 are processed for storage and generation of information, and also processed by the anomaly-detection manager 1008 to determine when anomalies occur due to deviations of the incoming data from the expected or forecasted data.

An anomaly reporter 1014 reports the detected anomalies via the he anomaly-detection user interface 1018, or some other interfaces of the analysis platform 102.

An anomaly analyst 1016 analyzes the incoming data, generates forecasts, and determines when anomalies occur. The anomaly analyst 1016 includes prediction models 1020, training data 1023, validation data 1024, model evaluator 1026, forecaster 1028, and performance tracker 1030.

The prediction models 1020 is a set of models available for forecasting data. The model evaluator 1026 evaluates the different models for each metric (with different values of hyperparameters) to select one model with a hyperparameter configuration to make predictions. The training data 1023 and validation data 1024 are used to train and validate the models, as described above with reference to FIG. 8.

The forecaster 1028 creates the predictions for each metric using the selected model, and the performance tracker 1030 monitors the variations between actual and forecast to determine when to set alarms.

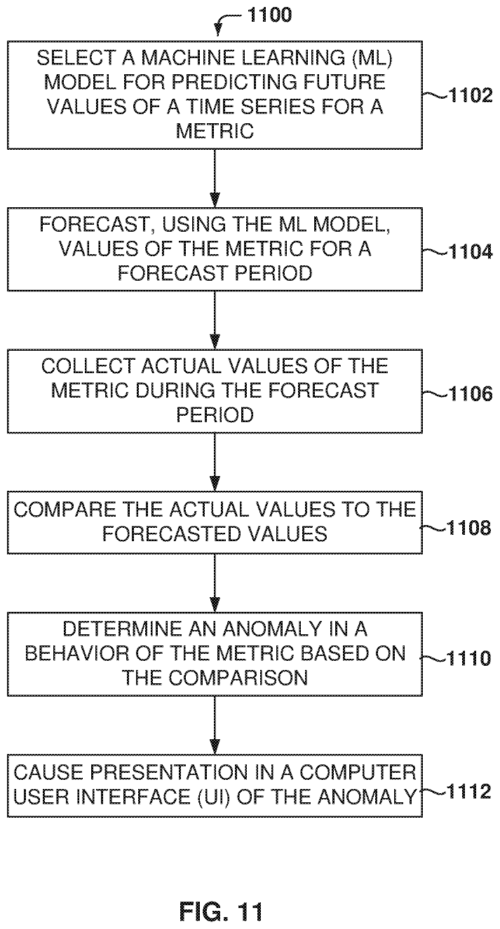

FIG. 11 is a flowchart of a method for problem detection based on deviations from the forecasted behavior of a metric, according to some example embodiments. While the various operations in this flowchart are presented and described sequentially, one of ordinary skill will appreciate that some or all of the operations may be executed in a different order, be combined or omitted, or be executed in parallel.

Operation 1102 is for selecting a machine learning (ML) model for predicting future values of a time series for a metric.

From operation 1102, the method flows to operation 1104 to forecast, using the ML model, values of the metric for a forecast period.

From operation 1104, the method flows to operation 1106 to collect actual values of the metric during the forecast period.

From operation 1106, the method flows to operation 1108 to compare the actual values to the forecasted values.

From operation 1108, the method flows to operation 1110 to determine that an anomaly in a behavior of the metric based on the comparison.

From operation 1110, the method flows to operation 1112 for causing presentation in a computer user interface (UI) of the anomaly.

In one example, selecting the ML model further comprises: testing a first model with several hyperparameter configurations, the testing of the first model with one of the hyperparameter configurations comprising selecting values for one or more hyperparameters of the first model, training the first model with the selected values, and calculating an accuracy of the first model, using validation data, for the selected values for the one or more hyperparameters; and selecting the hyperparameter configuration with a highest accuracy.

In one example, collecting actual values comprises obtaining data for the time series of the metric received via logs or metrics data, and inserting the obtained data in the time series of the metric.

In one example, comparing the actual values with the forecasted values comprises calculating, for each time value in the time series of the metric, a difference between the forecasted value of the metric and the actual value of the metric.

In one example, determining the anomaly further comprises determining that an anomaly has occurred when a difference between the forecasted values and the actual values is above a predetermined threshold for a period greater than a predetermined time threshold.

In one example, causing presentation in the UI further comprises presenting in the UI a graph of a time series of the actual values and a time series of the forecasted values.

In one example, the ML model is selected from a group comprising an AR model and a SARMA model, the AR model having a lags hyperparameter, the SARMA model having hyperparameters comprising a trend autoregressive order, a trend difference order, a trend moving average order, a number of time steps for a single seasonal period, a seasonal autoregressive order, a seasonal differencing order, and a seasonal moving average order.

In one example, selecting the ML model further comprises utilizing gradient search to select hyperparameter values for the ML model.

In one example, the anomaly is one of change detection, slow drift, sudden change from zero, sudden change to zero, or transient spike.

In one example, the ML model is configured to detect seasonalities in training data to forecast the values of the metric.

Another general aspect is for a system that includes a memory comprising instructions and one or more computer processors. The instructions, when executed by the one or more computer processors, cause the one or more computer processors to perform operations comprising: selecting a machine learning (ML) model for predicting future values of a time series for a metric; forecasting, using the ML model, values of the metric for a forecast period; collecting actual values of the metric during the forecast period; comparing the actual values to the forecasted values; determining an anomaly in a behavior of the metric based on the comparison; and causing presentation in a computer user interface (UI) of the anomaly.

In yet another general aspect, a tangible machine-readable storage medium (e.g., a non-transitory storage medium) includes instructions that, when executed by a machine, cause the machine to perform operations comprising: selecting a machine learning (ML) model for predicting future values of a time series for a metric; forecasting, using the ML model, values of the metric for a forecast period; collecting actual values of the metric during the forecast period; comparing the actual values to the forecasted values; determining an anomaly in a behavior of the metric based on the comparison; and causing presentation in a computer user interface (UI) of the anomaly.

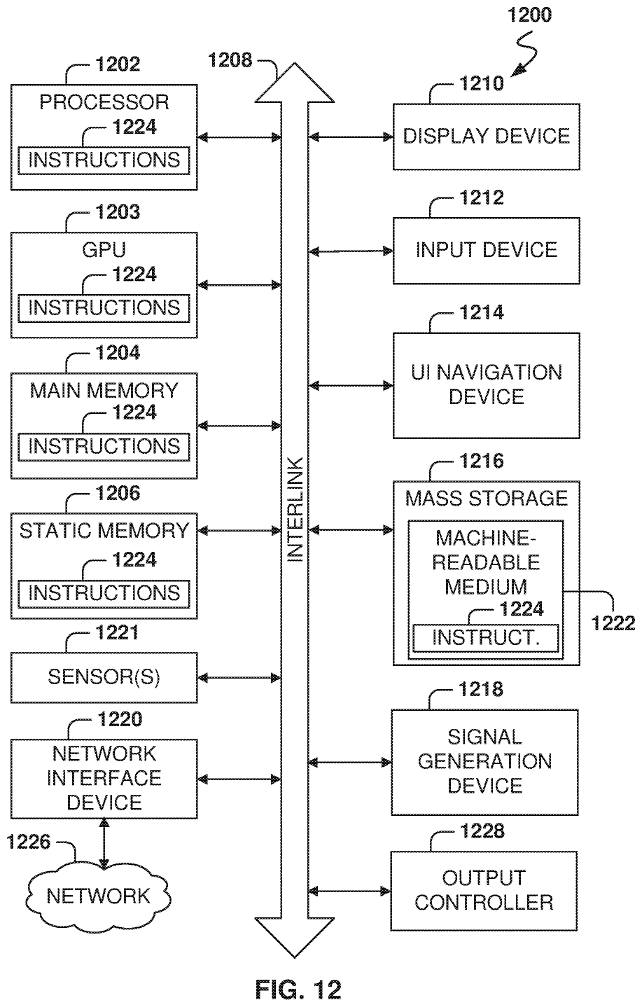

FIG. 12 is a block diagram illustrating an example of a machine 1200 upon or by which one or more example process embodiments described herein may be implemented or controlled. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in a peer-to-peer (P2P) (or other distributed) network environment. Further, while only a single machine 1200 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine 1200 (e.g., computer system) may include a hardware processor 1202 (e.g., a central processing unit (CPU), a hardware processor core, or any combination thereof), a graphics processing unit (GPU 1203), a main memory 1204, and a static memory 1206, some or all of which may communicate with each other via an interlink 1208 (e.g., bus). The machine 1200 may further include a display device 1210, an alphanumeric input device 1212 (e.g., a keyboard), and a computer user interface (UI) navigation device 1214 (e.g., a mouse). In an example, the display device 1210, alphanumeric input device 1212, and UI navigation device 1214 may be a touch screen display. The machine 1200 may additionally include a mass storage device 1216 (e.g., drive unit), a signal generation device 1218 (e.g., a speaker), a network interface device 1220, and one or more sensors 1221, such as a Global Positioning System (GPS) sensor, compass, accelerometer, or another sensor. The machine 1200 may include an output controller 1228, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1216 may include a machine-readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, within the hardware processor 1202, or within the GPU 1203 during execution thereof by the machine 1200. In an example, one or any combination of the hardware processor 1202, the GPU 1203, the main memory 1204, the static memory 1206, or the mass storage device 1216 may constitute machine-readable media.

While the machine-readable medium 1222 is illustrated as a single medium, the term “machine-readable medium” may include a single medium, or multiple media, (e.g., a centralized or distributed database, and/or associated caches and servers) configured to store the one or more instructions 1224.

The term “machine-readable medium” may include any medium that is capable of storing, encoding, or carrying instructions 1224 for execution by the machine 1200 and that cause the machine 1200 to perform any one or more of the techniques of the present disclosure, or that is capable of storing, encoding, or carrying data structures used by or associated with such instructions 1224. Non-limiting machine-readable medium examples may include solid-state memories, and optical and magnetic media. In an example, a massed machine-readable medium comprises a machine-readable medium 1222 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device 1220.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
selecting a machine learning (ML) model for predicting future values of a time series for a metric;
forecasting, using the ML model, values of the metric for a forecast period;
collecting actual values of the metric during the forecast period;
comparing the actual values to the forecasted values;
determining an anomaly in a behavior of the metric based on the comparison; and
causing presentation in a computer user interface (UI) of the anomaly.

2. The method as recited in claim 1, wherein selecting the ML model further comprises:
testing a first model with several hyperparameter configurations, the testing of the first model with one of the hyperparameter configurations comprising:
selecting values for one or more hyperparameters of the first model;
training the first model with the selected values; and
calculating an accuracy of the first model, using validation data, for the selected values for the one or more hyperparameters; and
selecting the hyperparameter configuration with a highest accuracy.

3. The method as recited in claim 1, wherein collecting actual values comprises:
obtaining data for the time series of the metric received via logs or metrics data; and
inserting the obtained data in the time series of the metric.

4. The method as recited in claim 1, wherein comparing the actual values with the forecasted values comprises:
calculating, for each time value in the time series of the metric, a difference between the forecasted value of the metric and the actual value of the metric.

5. The method as recited in claim 1, wherein determining the anomaly further comprises:
determining that an anomaly has occurred when a difference between the forecasted values and the actual values is above a predetermined threshold for a period greater than a predetermined time threshold.

6. The method as recited in claim 1, wherein causing presentation in the UI further comprises:
presenting in the UI a graph of a time series of the actual values and a time series of the forecasted values.

7. The method as recited in claim 1, wherein the ML model is selected from a group comprising an AR model and a SARMA model, the AR model having a lags hyperparameter, the SARMA model having hyperparameters comprising a trend autoregressive order, a trend difference order, a trend moving average order, a number of time steps for a single seasonal period, a seasonal autoregressive order, a seasonal differencing order, and a seasonal moving average order.

8. The method as recited in claim 7, wherein selecting the ML model further comprises:
utilizing gradient search to select hyperparameter values for the ML model.

9. The method as recited in claim 1, wherein the anomaly is one of change detection, slow drift, sudden change from zero, sudden change to zero, or transient spike.

10. The method as recited in claim 1, wherein the ML model is configured to detect seasonalities in training data to forecast the values of the metric.

11. A system comprising:
a memory comprising instructions; and
one or more computer processors, wherein the instructions, when executed by the one or more computer processors, cause the system to perform operations comprising:
selecting a machine learning (ML) model for predicting future values of a time series for a metric;
forecasting, using the ML model, values of the metric for a forecast period;
collecting actual values of the metric during the forecast period;
comparing the actual values with to forecasted values;
determining an anomaly in a behavior of the metric based on the comparison; and
causing presentation in a computer user interface (UI) of the anomaly.

12. The system as recited in claim 11, wherein selecting the ML model further comprises:
testing a first model with several hyperparameter configurations, the testing of the first model with one of the hyperparameter configurations comprising:
selecting values for one or more hyperparameters of the first model;
training the first model with the selected values; and
calculating an accuracy of the first model, using validation data, for the selected values for the one or more hyperparameters; and
selecting the hyperparameter configuration with a highest accuracy.

13. The system as recited in claim 11, wherein collecting actual values comprises:
obtaining data for the time series of the metric received via logs or metrics data; and
inserting the obtained data in the time series of the metric.

14. The system as recited in claim 11, wherein comparing the actual values with the forecasted values comprises:
calculating, for each time value in the time series of the metric, a difference between the forecasted value of the metric and the actual value of the metric.

15. The system as recited in claim 11, wherein determining the anomaly further comprises:
determining that an anomaly has occurred when a difference between the forecasted values and the actual values is above a predetermined threshold for a period greater than a predetermined time threshold.

16. A tangible machine-readable storage medium including instructions that, when executed by a machine, cause the machine to perform operations comprising:
selecting a machine learning (ML) model for predicting future values of a time series for a metric;
forecasting, using the ML model, values of the metric for a forecast period;
collecting actual values of the metric during the forecast period;
comparing the actual values to the forecasted values;
determining an anomaly in a behavior of the metric based on the comparison; and
causing presentation in a computer user interface (UI) of the anomaly.

17. The tangible machine-readable storage medium as recited in claim 16, wherein selecting the ML model further comprises:
testing a first model with several hyperparameter configurations, the testing of the first model with one of the hyperparameter configurations comprising:
selecting values for one or more hyperparameters of the first model;
training the first model with the selected values; and
calculating an accuracy of the first model, using validation data, for the selected values for the one or more hyperparameters; and
selecting the hyperparameter configuration with a highest accuracy.

18. The tangible machine-readable storage medium as recited in claim 16, wherein collecting actual values comprises:
obtaining data for the time series of the metric received via logs or metrics data; and
inserting the obtained data in the time series of the metric.

19. The tangible machine-readable storage medium as recited in claim 16, wherein comparing the actual values with the forecasted values comprises:
calculating, for each time value in the time series of the metric, a difference between the forecasted value of the metric and the actual value of the metric.

20. The tangible machine-readable storage medium as recited in claim 16, wherein determining the anomaly further comprises:
determining that an anomaly has occurred when a difference between the forecasted values and the actual values is above a predetermined threshold for a period greater than a predetermined time threshold.
